(19) United States
(12) Patent Application Publication
(10) Pub. No.: US 2003/0165603 A1
(43) Pub. Date: Sep. 4, 2003

(54) Natural fruit-based sweetener blend compositions

(76) Inventors: Cindy A. Burklow, St. Louis, MO (US); Chifu Huang, St. Louis, MO (US)

Correspondence Address: Cindy A. Burklow, 169 Swigert Avenue, Lexington, KY, 40505, US

(21) Appl. No.: 10/086,322

(22) Filed: Mar. 1, 2002

(51) Int. Cl. A23L 1/236

(52) U.S. Cl. 426/548

(57) ABSTRACT

Natural sweetener blend compositions containing Lo Han Kuo (Momordica Grosvenori Swingle) fruit concentrate powder, fructose, and maltodextrin. Specifically, new and improved Lo Han Kuo fruit-based natural sweetener blend compositions include an improved Lo Han Kuo fruit concentrate powder (a lighter yellow powder that is 300 times sweeter than refined cane sugar and has no bitter aftertaste), crystalline fructose, and maltodextrin. Furthermore, such new and improved Lo Han Kuo fruit-based natural sweetener blend compositions provide a sweetness level in the range of 3 times to 10 times sweeter than refined cane sugar. The present invention also involves the use of the improved Lo Han Kuo fruit concentrate powder ingredient in combination with fructose and maltodextrin to eradicate undesired lingering aftertaste, so that the sweetener blend compositions no longer exhibit lingering aftertaste.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates generally to the field of sweetener blend compositions, and relates specifically to the field of natural sweetener blend compositions including Lo Han Kuo fruit concentrate powder as a component.

2. Description of Prior Art

Carbohydrates have always been a major part of the human diet. One such carbohydrate that has been used widely as a food ingredient is sugar. Sugar has played a significant role in the daily diets of humans. Over the past several years, there has been a growing concern of having too much sugar consumption in the human diet. It is a well-established fact that too much sugar consumption can have negative heath effects, namely the development of diabetes and obesity. However, even with the negative effects of excess consumption of sugar, sugar is still critical to the taste of foods and beverages, namely to sweeten both food and beverage products. Therefore, it is still important to maintain some type of sugar-like sweetening agent as an ingredient in food and beverage products. Furthermore, sugar is inexpensive and this is why many companies continue to choose to use sugar as the ingredient of choice to sweeten their food and beverage products. In response to the growing health concerns and the need for ingredients to sweeten both food and beverage products, many companies have developed new sweetener products to address the negative issues associated with sugar and to provide ingredients that can be substituted for sugar to sweeten both food and beverage products.

Over the years, three types of sugar alternative sweetener products have arisen that can be categorized as synthetic sweeteners, refined sweeteners, and natural sweeteners. There have been a large variety of sweetener blend compositions that have been disclosed in the prior art for use in various food and beverage products.

The first category of sugar alternative sweetener products is synthetic sweeteners. Several major pharmaceutical companies, namely Monsanto and Searle, have developed chemical compounds that taste sweet and are low in calories that can be used in both food and beverage products. These sweetening chemical compounds form the basis of synthetic sweetener blend composition products and are promoted as low calorie sweeteners. Many of these low calorie sweetener blend compositions contain synthetic sweetening ingredients such as saccharine, aspartame, cyclamate, dipeptides, and Acesulfame K. These low calorie synthetic sweetener blend compositions are prepared by diluting the intense synthetic sweetener ingredient with dextrose, corn syrup solids, sucrose, polyglucose, and maltodextrins. Many of these synthetic sweetener blends are marketed under the name of Sweet-n-Low, Equal, NutraSweet, and many other various private labels.

The second category of sugar alternative sweetener products is refined sweeteners. Refined sweeteners are sweetening ingredients that have been further processed and refined from other raw ingredients to attain desirable attributes in order for the refined ingredient to be used as a sweetening agent. Several examples of refined sweeteners used in sugar alternative sweetener blend compositions are corn syrup, dextrose, refined fructose, refined polysaccharides, sucralose, and brown sugar. Many of these refined sugar sweetener blends are used widely in numerous food and beverage products since these sweetener blend compositions are less expensive than synthetic sweeteners. For example, there is a sucralose-based sweetener blend composition that is marketed by McNeil Specialty Products, Co. under the brand name of Splenda.

The third category of sugar alternative sweetener products is all natural sweeteners. Natural sweeteners contain no synthetic additives or man-made chemicals. Examples of natural sweeteners are honey, fructans, fructose, molasses, inulin, levan, polysaccharides, fructo-oligosaccharides, isomalto, maple syrup products, hydrolyzed whole grain (sorghum, rice, and barley) products, cane juice, Lo Han Kuo fruit concentrate, apple concentrate, grape concentrate, fruit concentrate powders, liquid fruit concentrates, and many other fruit-based powders. Some of these natural sweeteners are low calorie while other natural sweeteners are still high in calories, but all of the natural sweeteners are promoted as an all-natural alternative to sugar. For example, there are various sweetener blend compositions that contain honey, molasses, fruit powder, or Lo Han Kuo fruit concentrate that are promoted by various companies as natural alternatives to refined cane sugar to sweeten food and beverage products. By way of example and not limitation, the sweeteners that contain Lo Han Kuo fruit are FrutSweet (patent pending) distributed by Western Commerce Corporation and claims to be 25 times sweeter than refined sugar and is marketed to manufacturers, and SlimSweet distributed by Trimedica, Inc. and claims to be 15 times sweeter than refined sugar and is marketed to consumers. It is important to note that all of the sweetener blend compositions containing Lo Han Kuo fruit only contain the ingredients of Lo Han Kuo fruit concentrate that is 250 times sweeter than refined sugar, fructose, and silicon dioxide. All of the sweetener blend compositions that contain Lo Han Kuo fruit have a bitter aftertaste and do not use any maltodextrin as an ingredient, a bulking agent, or a base.

Since some of the low calorie sweeteners and sugar alternative sweetener blends use synthetic ingredients that are connected with controversial issues and some of the refined sweeteners and natural sweeteners are not low in calories, the recent trend in the food technology industry is aimed at providing high quality sweetener blend composition products that contain all-natural ingredients and are yet still low in calories.

This need for low calorie, sugar substitute sweetener has been the catalyst for many companies and individuals to patent sweetener blend compositions that are promoted as alternatives to sugar and as improvements of past sweetener blend compositions. Namely, by way of exemplification and not limitation in this regard, reference is had herein, for instance, to U.S. Pat. No. 5,492,715 entitled “Dual Function Fruit Concentrate Sweetener and Fat Substitute and Method of Making”, which issued on Feb. 20, 1996. In accordance with the teachings of U.S. Pat. No. 5,492,715, there is provided a sweetener blend composition that can function both as a fruit concentrate (specifically grape juice concentrate) and a fat substitute. This aforementioned example shows a sweetener blend composition that is a fruit-based sweetener (specifically grape) that can be used both as a sugar substitute and a fat substitute.

Another example, by way of exemplification and not limitation in this regard, reference is had herein, for instance, to U.S. Pat. No. 5,510,123 entitled “Food Sweetener Composition and Process”, which issued on Apr. 23, 1996. In accordance with the teachings of U.S. Pat. No. 5,510,123, there is provided food sweetener compositions containing aspartame and sugar acids, which eradicates the undesired lingering aftertaste of aspartame without contributing to viscosity or pulp volume. This aforedescribed example shows new and improved aspartame-based sweetener blend compositions that provide better sweetener blend compositions that removed unpleasant and unwanted aftertaste without adding unwanted viscosity or pulp volume; hence, making the product more desirable to both manufacturers and consumers.

Another example, by way of exemplification and not limitation in this regard, reference is had herein, for instance, to U.S. Pat. No. 6,180,155, entitled “Sweetener Having an Improved Sucrose-like Taste and Process For the Preparation Thereof and Use Thereof”, which issued on Jan. 30, 2001. In accordance with the teachings of U.S. Pat. No. 6,180,155, there is provided a sweetener having an improved sucrose-like taste, which contains at least one synthetic sweetener or a mixture of different artificial sweeteners and at least one deoxysugar, in particular rhamnose or fucose. The aforementioned example shows a sweetener blend composition that is a new and improved sweetener blend composition that makes the synthetic sweetener blend composition more like refined table sugar, which is preferred by the consumer.

The aforedescribed patents are examples of sweetener blend compositions that have provided new and improved sweetener blend compositions. Likewise, a need has arisen in the prior art in the sweetener blend composition industry, specifically natural sweetener blend composition industry, to also take advantage of the improved blending of different natural ingredients as well as the technological advances in ingredient flavor quality improvements, namely an improved ingredient of Lo Han Kuo fruit concentrate powder that contains no bitter taste and is 300 times sweeter than refined cane sugar to provide new and improved Lo Han Kuo fruit-based natural sweetener blend compositions for consumers and manufacturers. Furthermore, it is noted again that the preceding prior art references are merely illustrative or representative of a substantial number of references disclosing similar products for use either as low calorie sweeteners blends, sugar substitute blends, but not in the composition of Lo Han Kuo concentrate powder (300 times sweeter than refined cane sugar), fructose, and maltodextrin. Our present invention provides new and improved Lo Han Kuo fruit-based natural sweetener blend compositions.

It is important to note that there are many disadvantages to the sweetener blend compositions of the prior art. The first disadvantage to the prior sweetener blend compositions is that many of the sweetening ingredients (e.g. inulin, fructo-oligosaccharides, some synthetic sweetening ingredients) are very expensive and cost prohibitive for both manufacturers and consumers to use in place of sugar on a regular basis. The higher costs of prior sweetener blend compositions relative to the cost of sugar make such sweetener blend compositions uneconomical for many food and beverage applications where sugar is currently being used. Also, the natural sweetener blend compositions that contain Lo Han Kuo fruit are very expensive since these sweetener blend compositions are formulated at a higher sweetness concentration level (e.g. 15 times and 25 times sweeter than refined cane sugar). Therefore, these higher costs make it very difficult for both manufacturers and consumers to completely naturally replace sugar in the human diet.

The second disadvantage to the prior sweetener blend compositions is that there is an unpleasant aftertaste and a distinct flavor that make the prior sweetener blend compositions undesirable to use in place of sugar or to use as an ingredient substitute in some food and beverage applications. This aftertaste, which is characterized as a bitter, or a metallic flavor, continues or lingers for a period of time in excess of five seconds after the sweetener blend composition has exited the oral cavity. Specifically, sweetener blend compositions that contain Lo Han Kuo fruit have a strong bitter aftertaste and unpleasant flavor that is unfavorable to both consumers and manufacturers.

The third disadvantage to the prior art is that many of the ingredients of the sweetener blend compositions do not blend well together and often separate over a short period of time. These ingredients separate within the packaging with general use by the customer. For exemplification and not limitations, the sweetener blend compositions that contain Lo Han Kuo fruit concentrate powder blended with fructose and silicon dioxide separates easily from the Lo Han Kuo fruit concentrate powder. Furthermore, the Lo Han Kuo fruit concentrate powder settles at the bottom of the container, which weakens the sweetness level for the overall sweetener blend composition and makes the sweetness level inconsistent for each individual serving size. In addition, the separation of the ingredients in the prior art makes the physical appearance of the sweetener blend composition unattractive, which makes the sweetener blend composition problematic to market to both consumers and manufacturers.

The fourth disadvantage to the prior art is that some of the sweetening ingredients decompose under certain food processing conditions and lose their sweetness when heated. Hence, the sweetener blend composition is rendered useless in cooking, baking, and other heating applications.

The fifth disadvantage to the prior art is that many of the low calorie synthetic sweetener alternatives have been connected with carcinogenicity issues and other potentially hazardous side effects.

The sixth disadvantage to the prior art is that some ingredients used to sweeten the sweetener blend compositions, namely oligosaccharides, isomalto, fructo-oligosaccharides, have a laxative effect on the body if consumed too much. Therefore, making it difficult for both manufacturers and consumers to completely replace sugar using these ingredients.

The seventh disadvantage to the prior art is that the sweetener blend compositions containing Lo Han Kuo fruit are too concentrated for the consumer and have higher sweetness levels in comparison to the sweetness level of refined cane sugar. Hence, making the prior sweetener blend compositions very confusing and difficult for the consumer to use. The consumer cannot measure the product like refined cane sugar. The consumer has to make a measurement conversion to the manufacturer's designated measurements in order to get the proper equivalent to standard refined cane sugar measurements. The consumers cannot freely use the product properly without the manufacturer's designated measurement standards. There are no teaspoon-to-teaspoon refined cane sugar equivalent measurements for sweetener blend compositions containing Lo Han Kuo fruit. Specifically, the sweetener blend compositions that contain Lo Han Kuo fruit come only in two sweetness levels of 15 times and 25 times sweeter than refined cane sugar. Therefore, the consumer must convert these concentrated sweetener blend compositions containing Lo Han Kuo fruit to a particular measurement in order to measure like refined cane sugar. The consumer has to use a special measurement instead of the measurement that the consumer is accustomed to using. These higher concentrated levels make it difficult for the consumer to easily cook, bake, mix, and use daily with food and beverage products. In the prior art, there is a tendency for the consumer to add too much of the sweetener blend composition containing Lo Han Kuo fruit to food and beverage products, since the consumer is accustomed to the measurements of adding refined cane sugar, which is less sweeter than the concentrated sweetener blend compositions, to food and beverage products at a certain usage level. Therefore, it is very easy for the consumer to over use and over sweeten a product that they want to sweeten. Once the product is over sweetened, the consumer finds it very difficult to remove this extra sweetness from the product that they try to sweeten by adding the highly concentrated sweetener blend composition containing Lo Han Kuo fruit.

The eighth disadvantage to the prior art is that the sweetener blend compositions contain ingredients that are undesirable to some consumers. For example and not limiting, the prior sweetener blend compositions containing Lo Han Kuo fruit contained one such undesirable ingredient, silicon dioxide, which is a known anti-caking agent. Many consumers prefer not to have this particular chemical ingredient in their all-natural sweetener products.

The ninth disadvantage to the prior art is that the coloring of the sweetener blend compositions containing Lo Han Kuo fruit is either too yellow or too brown in coloring. This discoloring is unpopular with consumers since the consumer is used to the white coloring of refined cane sugar. White is perceived as pure and the yellowish brown tinting of the sweetener blend compositions containing Lo Han Kuo fruit make the consumer think that the product is tainted and not pure. Moreover, the uneven distribution of ingredients creates an irregular coloration in the sweetener blend composition, which further contributes to the consumer's perception of an impure product.

The tenth disadvantage to the prior art is that there is a limited selection of sweetness levels for sweetener blend compositions containing Lo Han Kuo fruit. There are only two sweetness levels offered to the consumer, namely 15 times sweeter than refined cane sugar and 25 times sweeter than refined cane sugar. Most consumers have different taste and sweetness level preferences. In addition, consumers prefer to have a sweetener blend composition that is closer in the range of the sweetness level of refined cane sugar.

The eleventh disadvantage to the prior art is that none of the sweetener blend compositions containing Lo Han Kuo fruit contain maltodextrin as an ingredient or a bulking agent.

The aforedescribed disadvantages in the prior art have further increased the need for new and improved Lo Han Kuo fruit-based natural sweetener blend compositions. Furthermore, diabetics, health-conscious consumers, and weight-control consumers have further fueled the need and the desire for sugar-free, low calorie, all-natural sweetener blend compositions. A need has arisen in the prior art for new and improved Lo Han Kuo fruit-based natural sweetener blend compositions that have a pleasant sweet flavor and do not have an unpleasant bitter aftertaste. Therefore, a need has become self-evident in the practices of the prior art for new and improved Lo Han Kuo fruit-based natural sweetener blend compositions that contain a higher-grade, improved Lo Han Kuo fruit concentrate powder that is 300 times sweeter than refined cane sugar and does not have a bitter aftertaste and is lighter yellow in coloring. Likewise, a great need still exists for new and improved Lo Han Kuo fruit-based natural sweetener blend compositions, which are balanced by a total replacement of sugar by natural “sugar substitute” ingredients while still offering the taste and the physical properties of refined cane sugar. In addition, a need exists for new and improved Lo Han Kuo fruitbased natural sweetener blend compositions that are powder formulas and can be used and measured more in close proportion to refined cane sugar. Moreover, a need has arisen in the prior art for new and improved Lo Han Kuo fruit-based natural sweetener blend compositions that have a sweetness level range from 3 times sweeter than refined cane sugar to 10 times sweeter than refined cane sugar. Even more so, the practices of the prior art show a further need for new and improved Lo Han Kuo fruit-based natural sweetener blend compositions that contain an improved Lo Han Kuo fruit concentrate powder (300 times sweeter than refined cane sugar), crystalline fructose, and maltodextrin.

Therefore, all of these combined needs evidenced in the prior art in the sweetener blend composition industry call for new and improved Lo Han Kuo fruit-based natural sweetener blend compositions that are powder formulas that contain an improved Lo Han Kuo fruit concentrate powder (300 times sweeter than refined cane sugar), crystalline fructose, and maltodextrin and that such new and improved Lo Han Kuo fruit-based natural sweetener blend compositions come in a sweetness level range of 3 to 10 times sweeter than refined cane sugar and also the sweetener blend compositions look and taste more like refined cane sugar and do not contain a bitter after-taste.

The needed new and improved Lo Han Kuo fruit-based natural sweetener blend compositions, which have been evidenced in the prior art, have a number of characteristics. The first characteristic of such new and improved Lo Han Kuo fruit-based natural sweetener blend compositions contain an improved Lo Han Kuo fruit concentrate powder (300 times sweeter than refined cane sugar), fructose, and maltodextrin and such new and improved sweetener blend compositions have a sweetness level range of 3 times sweeter than refined cane sugar to 10 times sweeter than refined cane sugar.

The second characteristic of such new and improved Lo Han Kuo fruit-based natural sweetener blend compositions is that the Lo Han Kuo fruit-based natural sweetener blend compositions do not leave an after-taste or unpleasant bitter flavor. Furthermore, such new and improved Lo Han Kuo fruit-based natural sweetener blend compositions should have a pleasant sweet flavor. Therefore, the Lo Han Kuo fruit-based natural sweetener blend compositions contain an improved Lo Han Kuo fruit concentrate powder that is 300 times sweeter than refined cane sugar and does not contain any bitter after-taste.

The third characteristic of such new and improved Lo Han Kuo fruit-based natural sweetener blend compositions is that the sweetener blend compositions do not contain unwanted chemical anti-caking agents, namely silicon dioxide.

The fourth characteristic of such new and improved Lo Han Kuo fruit-based natural sweetener blend compositions is that the sweetener blend compositions do not have a laxative effect if consumed in large amounts and consumed on a regular basis.

The fifth characteristic of such new and improved Lo Han Kuo fruit-based natural sweetener blend compositions is that the sweetener blend compositions' sweetness levels are not too concentrated for the consumer. Hence, the sweetness concentrated level choices of such new and improved Lo Han Kuo fruit-based natural sweetener blend compositions are in a range of 3 times sweetener than refined cane sugar to 10 times sweetener than refined cane sugar.

The sixth characteristic of such new and improved Lo Han Kuo fruit-based natural sweetener blend compositions is that the sweetener blend compositions do not break down under cooking, baking, and other heating applications and maintains its sweetness. Furthermore, the sweetener blend compositions' powdered ingredients stay blended together and maintain its consistent sweetness level per each individual serving. In addition, the sweetener blend compositions are lighter in coloring preferably white and white with light yellow highlights and are not a brown or dark yellow coloring with white highlights.

The seventh characteristic of such new and improved Lo Han Kuo fruit-based natural sweetener blend compositions is that the sweetener blend compositions dissolve easily in water and other liquids, namely alcohol.

The eighth characteristic of such new and improved Lo Han Kuo fruit-based natural sweetener blend compositions is that the sweetener blend compositions are more cost effective for both manufacturers and consumers to use as a replacement for sugar in comparison to other sweetener blend compositions containing Lo Han Kuo fruit.

There are many benefits of such new and improved Lo Han Kuo fruit-based natural sweetener blend compositions. One such benefit is that such new and improved Lo Han Kuo fruit-based natural sweetener blend compositions provide a more convenient and easier to use powder formula for the customer to more easily measure and use like refined cane sugar. Another such benefit is that such new and improved Lo Han Kuo fruit-based natural sweetener blend compositions are-less expensive than other sweetener blend compositions containing Lo Han Kuo fruit on the market and are more cost effective in comparison to other sweetener blend compositions containing Lo Han Kuo fruit. Yet another such benefit is that such new and improved Lo Han Kuo fruit-based natural sweetener blend compositions provide the customer more variety of sweetness concentration levels that are not being previously offered to consumers, namely a range of 3 times to 10 times sweeter than refined cane sugar. Another such benefit is that such new and improved Lo Han Kuo fruit-based natural sweetener blend compositions are more marketable to customers since they look, taste, and feel more like refined cane sugar. Yet still another such benefit is that such new and improved Lo Han Kuo fruit-based natural sweetener blend compositions do not have a laxative effect if consumed in large quantities and are ideal for daily use in all food and beverage products. Another such benefit is that such new and improved Lo Han Kuo fruit-based natural sweetener blend compositions taste more closely to refined cane sugar and do not leave an unpleasant aftertaste and do not have a bitter flavor. Yet another benefit is that such new improved Lo Han Kuo fruit-based natural sweetener blend compositions contain ingredients (e.g. Lo Han Kuo fruit concentrate powder that is 300 times sweeter than refined cane sugar, fructose, and maltodextrin), which have been proven to not significantly raise blood sugar namely glucose levels in the blood. Yet still another benefit is that such new and improved Lo Han Kuo fruit-based natural sweetener blend compositions contain all-natural ingredients and do not contain any artificial, synthetic ingredients. Another benefit is that such new and improved Lo Han Kuo fruit-based natural sweetener blend compositions contain no sugar, are low in calories, and contain no fat. Yet still another benefit is that such new and improved Lo Han Kuo fruit-based natural sweetener blend compositions do not lose their sweetness during heating applications. Therefore, such new and improved Lo Han Kuo fruit-based natural sweetener blend compositions are ideal for cooking, baking, mixing, and generally adding to any food and beverage applications for a sweetening effect. Another such benefit is that such new and improved Lo Han Kuo fruit-based natural sweetener blend compositions contain maltodextrin that is the bulking agent. Furthermore, maltodextrin has been used as a nonfat additive and does not act adversely on the intestinal tract. Yet still another such benefit is that such new and improved Lo Han Kuo fruit-based natural sweetener blend compositions are less hygroscopic than other sweetener blend compositions containing Lo Han Kuo fruit.

From the perspective of the manufacturer, such new and improved Lo Han Kuo fruit-based natural sweetener blend compositions are even more beneficial in that they are less expensive to produce since the proportion of the ingredients allows for the less expensive ingredients to be the main base. Furthermore, such new and improved Lo Han Kuo fruit-based natural sweetener blend compositions are more like refined cane sugar, which make it easier to use and to market to consumers.

From the perspective of the consumer, such new and improved Lo Han Kuo fruit-based natural sweetener blend compositions are even more beneficial in that such new and improved Lo Han Kuo fruit-based natural sweetener blend compositions provide more sweetness level options and are less expensive than other sweetener blend compositions containing Lo Han Kuo fruit. Furthermore, such new and improved Lo Han Kuo fruit-based natural sweetener blend compositions taste more like refined cane sugar and are easier to use since the sweetener blend compositions look, taste, and feel more like refined cane sugar. Moreover, such new and improved Lo Han Kuo fruit-based natural sweetener blend compositions are natural alternatives to refined cane sugar and are natural “sugar substitutes”.

The present invention provides sweetener blend compositions that have all of the aforedescribed characteristics of such new and improved Lo Han Kuo fruit-based natural sweetener blend compositions and the present invention provides all the benefits as aforedescribed for such new and improved Lo Han Kuo fruit-based natural sweetener blend compositions.

### SUMMARY OF THE INVENTION

The present invention involves Lo Han Kuo fruit-based natural sweetener blend compositions containing Lo Han Kuo fruit concentrate powder, fructose, and maltodextrin. Specifically, new and improved Lo Han Kuo fruit-based natural sweetener blend compositions that comprise an improved Lo Han Kuo fruit concentrate powder (a lighter yellow powder that is 300 times sweeter than refined cane sugar and has no bitter aftertaste), crystalline fructose, and maltodextrin. Furthermore, such new and improved Lo Han Kuo fruit-based natural sweetener blend compositions provide a sweetness level in a range of 3 times to 10 times sweeter than refined cane sugar. The present invention also involves the use of the improved Lo Han Kuo fruit concentrate powder ingredient in combination with crystalline fructose and maltodextrin ingredients to eradicate the undesired lingering aftertaste, so that the natural sweetener blend compositions no longer exhibit lingering aftertaste. Furthermore, the present invention also involves the use of such new and improved Lo Han Kuo fruit-based natural sweetener blend compositions in food and beverage products.

It is an object of the present invention to provide new and improved Lo Han Kuo fruit-based natural sweetener blend compositions.

It is still another object of the present invention to provide new and improved Lo Han Kuo fruit-based natural sweetener blend compositions containing an improved Lo Han Kuo fruit concentrate powder (300 times sweeter than refined cane sugar), fructose, and maltodextrin and such new and improved sweetener blend compositions that have a sweetness level range of 3 times sweeter than refined cane sugar to 10 times sweeter than refined cane sugar.

It is still yet another object of the present invention to provide new and improved Lo Han Kuo fruit-based natural sweetener blend compositions that do not contain unwanted chemical anti-caking agents, namely silicon dioxide.

It is yet another object of the present invention to provide new and improved Lo Han Kuo fruit-based natural sweetener blend compositions that do not have a laxative effect if consumed in large amount and consumed on a regular basis.

It is still yet another object of the present invention to provide new and improved Lo Han Kuo fruit-based natural sweetener blend compositions that have sweetness levels that are not too concentrated for the customers, namely sweetness concentration levels in a range of 3 times sweetener than refined cane sugar to 10 times sweetener than refined cane sugar.

It is still yet another object of the present invention to provide new and improved Lo Han Kuo fruit-based natural sweetener blend compositions that do not break down under cooking, baking, and other heating applications and maintain their sweetness.

It is another object of the present invention to provide new and improved Lo Han Kuo fruit-based natural sweetener blend compositions that the powdered ingredients stay blended together and maintain a consistent sweetness level per each individual serving.

It is yet another object of the present invention to provide new and improved Lo Han Kuo fruit-based natural sweetener blend compositions that are lighter in coloring preferably white and white with light yellow highlights and are not brown or dark yellow coloring with white highlights.

It is still another object of the present invention to provide new and improved Lo Han Kuo fruit-based natural sweetener blend compositions that dissolve easily in water and other liquids, namely alcohol.

It is yet still another object of the present invention to provide new and improved Lo Han Kuo fruit-based natural sweetener blend compositions that are more cost effective for both manufacturers and consumers to use in comparison to other sweetener blend compositions containing Lo Han Kuo fruit.

It is yet another object of the present invention to provide new and improved Lo Han Kuo fruit-based natural sweetener blend compositions that are contain no bitter flavor and aftertaste.

In accordance with the present invention there is provided new and improved Lo Han Kuo fruit-based natural sweetener blend compositions comprising Lo Han Kuo fruit concentrate, fructose, and maltodextrin. The Lo Han Kuo fruit-based natural sweetener blend compositions of the present invention contain the Lo Han Kuo fruit concentrate that is an improved Lo Han Kuo fruit concentrate that is a light yellow colored powder that is 300 times sweeter than refined cane sugar and is derived from the fruit of the Momordica Grosvenori Swingle and has a Mogroside level of 80% or greater on a dry weight basis and has no bitter after-taste. The fructose in the Lo Han Kuo fruit-based natural sweetener blend compositions of the present invention is crystalline fructose. The maltodextrin in the Lo Han Kuo fruit-based natural sweetener blend compositions of the present invention is maltodextrin that has a dextrose equivalent (D.E.) of 16-20 and can be derived from corn, rice, and any combinations thereof. The Lo Han Kuo fruit-based natural sweetener blend compositions of the present invention are in the form of crystalline, powder, particles, chips, flakes, spicules, and any combinations thereof. The Lo Han Kuo fruit-based natural sweetener blend compositions of the present invention have a sweetness level range of 3 times to 10 times sweeter than refined cane sugar and the sweetener blend compositions comprise Lo Han Kuo fruit concentrate, fructose, and maltodextrin and any combination thereof. The Lo Han Kuo fruit-based natural sweetener blend composition of the present invention that has a sweetness level of 3 times sweeter than refined cane sugar comprises about 0.15% to about 0.19% Lo Han Kuo fruit concentrate, about 95% crystalline fructose, and about 4.81% to about 4.85% maltodextrin on a dry weight basis of the sweetener blend composition that has a sweetness level of 3 times sweeter than refined cane sugar. The Lo Han Kuo fruit-based natural sweetener blend composition of the present invention that has a sweetness level of 4 times sweeter than refined cane sugar comprises about 0.20% to about 0.24% Lo Han Kuo fruit concentrate, about 95% crystalline fructose, and about 4.76% to about 4.80% rnaltodextrin on a dry weight basis of the sweetener blend composition that has a sweetness level of 4 times sweeter than refined cane sugar. The Lo Han Kuo fruit-based natural sweetener blend composition of the present invention that has a sweetness level of 5 times sweeter than refined cane sugar comprises about 0.25% to about 0.29% Lo Han Kuo fruit concentrate, about 95% crystalline fructose, and about 4.71% to about 4.75% maltodextrin on a dry weight basis of the sweetener blend composition that has a sweetness level of 5 times sweeter than refined cane sugar. The Lo Han Kuo fruit-based natural sweetener blend composition of the present invention that has a sweetness level of 6 times sweeter than refined cane sugar comprises about 0.30% to about 0.34% Lo Han Kuo fruit concentrate, about 95% crystalline fructose, and about 4.66% to about 4.70% maltodextrin on a dry weight basis of the sweetener blend composition that has a sweetness level of 6 times sweeter than refined cane sugar. The Lo Han Kuo fruit-based natural sweetener blend composition of the present invention that has a sweetness level of 7 times sweeter than refined cane sugar comprises about 0.35% to about 0.39% Lo Han Kuo fruit concentrate, about 95% crystalline fructose, and about 4.61% to about 4.65% maltodextrin on a dry weight basis of the sweetener blend composition that has a sweetness level of 7 times sweeter than refined cane sugar. The Lo Han Kuo fruit-based natural sweetener blend composition of the present invention that has a sweetness level of 8 times sweeter than refined cane sugar comprises about 0.40% to about 0.44% Lo Han Kuo fruit concentrate, about 95% crystalline fructose, and about 4.56% to about 4.60% maltodextrin on a dry weight basis of the sweetener blend composition that has a sweetness level of 8 times sweeter than refined cane sugar. The Lo Han Kuo fruit-based natural sweetener blend composition of the present invention that has a sweetness level of 9 times sweeter than refined cane sugar comprises about 0.45% to about 0.49% Lo Han Kuo fruit concentrate, about 95% crystalline fructose, and about 4.51% to about 4.55% maltodextrin on a dry weight basis of the sweetener blend composition that has a sweetness level of 9 times sweeter than refined cane sugar. The Lo Han Kuo fruit-based natural sweetener blend composition of the present invention that has a sweetness level of 10 times sweeter than refined cane sugar comprises about 0.50% to about 0.55% Lo Han Kuo fruit concentrate, about 95% crystalline fructose, and about 4.45% to about 4.50% maltodextrin on a dry weight basis of the sweetener blend composition that has a sweetness level of 10 times sweeter than refined cane sugar. The Lo Han Kuo fruit-based natural sweetener blend compositions of the present invention are created by dry mixing the ingredients and the ingredients (e.g. Lo Han Kuo fruit concentrate, fructose, and maltodextrin) are commercially available. The Lo Han Kuo fruit-based natural sweetener blend compositions of the present invention are for the use of the sweetener blend compositions for a stand alone sweetener, a sweetening ingredient to be added to food and beverage products, and a sweetening agent and sweetening ingredient in any food, beverage, candy, jams, jelly, cake mixes, ice cream, puddings, chewing gum, gelatins, confectionery products, bakery goods, any novelty food and beverage products, and any dietary supplement products.

### DESCRIPTION OF THE PREFERRED EMBODIMENTS

Preferred embodiments of the present invention will be disclosed with the following description and examples of the present invention.

In a preferred embodiment, Lo Han Kuo fruit-based natural sweetener blend compositions contain an improved Lo Han Kuo fruit concentrate powder that is lighter yellow in coloring, is 300 times sweeter than refined cane sugar, contains 80% or greater level of Mogroside, and has no bitter aftertaste.

The dextrose equivalent (D.E.) of the maltodextrin in the Lo Han Kuo fruit-based natural sweetener blend compositions is less than 20, and in a preferred embodiment, between 16 and 20. In yet another preferred embodiment, the maltodextrin is derived from corn. In still yet another embodiment, the maltodextrin is derived from rice. In the preferred embodiment, the fructose in the Lo Han Kuo fruit-based natural sweetener blend compositions is crystalline fructose.

The best embodiment of this present invention is the combination of ingredients of Lo Han Kuo fruit concentrate powder (300 times sweeter than refined cane sugar), crystalline fructose, and maltodextrin to be used as a tabletop sweetener and to be used to sweeten other food and beverage products.

### EXAMPLES

The following Table 1 is illustrative of the following: Lo Han Kuo fruit-based natural sweetener blend compositions containing Lo Han Kuo fruit concentrate powder, fructose, and maltodextrin. The following examples of ingredient proportions are not to be construed as limiting, but merely demonstrate exemplary compositions of the present invention.

TABLE 1
Proportion of ingredients based on dry weight basis

| | % of each ingredient in the Lo Han Kuo | | |
|---|---|---|---|
| | fruit-based natural sweetener blend compositions | | |
| Sweetness | Lo Han Kuo fruit | | |
| Concentration Levels | concentrate powder | | |
| (# of times | (300 times sweeter | | |
| sweeter than | than refined cane | Crystalline | |
| refined cane sugar) | sugar) | Fructose | Maltodextrin |
| 3 times | 0.15% ˜ 0.19% | 95% | 4.81% ˜ 4.85% |
| 4 times | 0.20% ˜ 0.24% | 95% | 4.76% ˜ 4.80% |
| 5 times | 0.25% ˜ 0.29% | 95% | 4.71% ˜ 4.75% |
| 6 times | 0.30% ˜ 0.34% | 95% | 4.66% ˜ 4.70% |
| 7 times | 0.35% ˜ 0.39% | 95% | 4.61% ˜ 4.65% |
| 8 times | 0.40% ˜ 0.44% | 95% | 4.56% ˜ 4.60% |
| 9 times | 0.45% ˜ 0.49% | 95% | 4.51% ˜ 4.55% |
| 10 times | 0.50% ˜ 0.55% | 95% | 4.45% ˜ 4.50% |

The above description and examples are included to illustrate the sweetener blend compositions of the preferred embodiments and is not meant to limit the scope of the invention. The scope of the invention is to be limited only by the following claims. From the above discussion, many variations will be apparent to one skilled in the art that would yet be encompassed by the spirit and scope of the invention.

What is claimed is:

1. Lo Han Kuo fruit-based natural sweetener blend compositions comprising: Lo Han Kuo fruit concentrate, fructose, and maltodextrin.

2. The Lo Han Kuo fruit-based natural sweetener blend compositions of claim 1, wherein said Lo Han Kuo fruit concentrate is an improved Lo Han Kuo fruit concentrate that is a light yellow colored powder that is 300 times sweeter than refined cane sugar.

3. The Lo Han Kuo fruit-based natural sweetener blend compositions of claim 2, wherein said Lo Han Kuo fruit concentrate is an improved Lo Han Kuo fruit concentrate that is derived from the fruit of the Momordica Grosvenori Swingle and has a Mogroside level of 80% or greater on a dry weight basis and has no bitter aftertaste.

4. The Lo Han Kuo fruit-based natural sweetener blend compositions of claim 1, wherein said fructose is crystalline fructose.

5. The Lo Han Kuo fruit-based natural sweetener blend compositions of claim 1, wherein said maltodextrin has a dextrose equivalent (D.E.) of 16-20.

6. The Lo Han Kuo fruit-based natural sweetener blend compositions of claim 1 wherein the maltodextrin is corn, rice, and any combination thereof.

7. The Lo Han Kuo fruit-based natural sweetener blend compositions of claim 1, wherein said sweetener blend compositions are in the form of crystalline, powder, particles, chips, flakes, spicules, and any combination thereof.

8. The Lo Han Kuo fruit-based natural sweetener blend compositions of claim 1, wherein said sweetener blend compositions have a sweetness level range of 3 times to 10 times sweeter than refined cane sugar and the sweetener blend compositions comprise Lo Han Kuo fruit concentrate, fructose, and maltodextrin and any combination thereof.

9. The Lo Han Kuo fruit-based natural sweetener blend compositions of claim 8, wherein said Lo Han Kuo fruit concentrate, fructose, and maltodextrin combination is about 0.15% to about 0.19% Lo Han Kuo fruit concentrate, about 95% crystalline fructose, and about 4.81% to about 4.85% maltodextrin on a dry weight basis of the sweetener blend composition that has the sweetness level of 3 times sweeter than refined cane sugar.

10. The Lo Han Kuo fruit-based natural sweetener blend compositions of claim 8, wherein said Lo Han Kuo fruit concentrate, fructose, and maltodextrin combination is about 0.20% to about 0.24% Lo Han Kuo fruit concentrate, about 95% crystalline fructose, and about 4.76% to about 4.80% maltodextrin on a dry weight basis of the sweetener blend composition that has the sweetness level of 4 times sweeter than refined cane sugar.

11. The Lo Han Kuo fruit-based natural sweetener blend compositions of claim 8, wherein said Lo Han Kuo fruit concentrate, fructose, and maltodextrin combination is about 0.25% to about 0.29% Lo Han Kuo fruit concentrate, about 95% crystalline fructose, and about 4.71% to about 4.75% maltodextrin on a dry weight basis of the sweetener blend composition that has the sweetness level of 5 times sweeter than refined cane sugar.

12. The Lo Han Kuo fruit-based natural sweetener blend compositions of claim 8, wherein said Lo Han Kuo fruit concentrate, fructose, and maltodextrin combination is about 0.30% to about 0.34% Lo Han Kuo fruit concentrate, about 95% crystalline, and about 4.66% to about 4.70% maltodextrin on a dry weight basis of the sweetener blend composition that has the sweetness level of 6 times sweeter than refined cane sugar.

13. The Lo Han Kuo fruit-based natural sweetener blend compositions of claim 8, wherein said Lo Han Kuo fruit concentrate, fructose, and maltodextrin combination is about 0.35% to about 0.39% Lo Han Kuo fruit concentrate, about 95% crystalline fructose, and about 4.61% to about 4.65% maltodextrin on a dry weight basis of the sweetener blend composition that has the sweetness level of 7 times sweeter than refined cane sugar.

14. The Lo Han Kuo fruit-based natural sweetener blend compositions of claim 8, wherein said Lo Han Kuo fruit concentrate, fructose, and maltodextrin combination is about 0.40% to about 0.44% Lo Han Kuo fruit concentrate, about 95% crystalline fructose, and about 4.56% to about 4.60% maltodextrin on a dry weight basis of the sweetener blend composition that has the sweetness level of 8 times sweeter than refined cane sugar.

15. The Lo Han Kuo fruit-based natural sweetener blend compositions of claim 8, wherein said Lo Han Kuo fruit concentrate, fructose, and maltodextrin combination is about 0.45% to about 0.49% Lo Han Kuo fruit concentrate, about 95% crystalline fructose, and about 4.51% to about 4.55% maltodextrin on a dry weight basis of the sweetener blend composition that has the sweetness level of 9 times sweeter than refined cane sugar.

16. The Lo Han Kuo fruit-based natural sweetener blend compositions of claim 8, wherein said Lo Han Kuo fruit concentrate, fructose, and maltodextrin combination is about 0.50% to about 0.55% Lo Han Kuo fruit concentrate, about 95% crystalline fructose, and about 4.45% to about 4.50% maltodextrin on a dry weight basis of the sweetener blend composition that has the sweetness level of 10 times sweeter than refined cane sugar.

17. The Lo Han Kuo fruit-based natural sweetener blend compositions of claim 1, wherein said sweetener blend compositions are created by dry mixing the ingredients.

18. The Lo Han Kuo fruit-based natural sweetener blend compositions of claim 1, wherein said Lo Han Kuo fruit concentrate, fructose, and maltodextrin are commercially available.

19. The Lo Han Kuo fruit-based natural sweetener blend compositions of claim 1 are for the use of the sweetener blend compositions for a stand alone sweetener, a sweetening ingredient to be added to food and beverage products, and a sweetening agent and sweetening ingredient in any food, beverage, candy, jams, jelly, cake mixes, ice cream, puddings, chewing gum, gelatins, confectionery products, bakery goods, any novelty food and beverage products, and any dietary supplement products.
